(19) United States
(12) Patent Application Publication
(10) Pub. No.: US 2017/0045891 A1
(43) Pub. Date: Feb. 16, 2017

(54) METHOD AND DEVICE FOR FLYING AND RETRIEVING UNMANNED AERIAL VEHICLE IN A HANDHELD WAY

(71) Applicant: BEIJING ZERO ZERO INFINITY TECHNOLOGY CO., LTD

(72) Inventors: Mengqiu WANG, Beijing (CN); Tong ZHANG, Beijing (CN); Qicheng LI, Beijing (CN); Jia LU, Beijing (CN); Lixin LIU, Beijing (CN)

(73) Assignee: BEIJING ZERO ZERO INFINITY TECHNOLOGY CO., LTD, Beijing (CN)

(21) Appl. No.: 15/108,190

(22) PCT Filed: Jan. 11, 2016
(86) PCT No.: PCT/CN2016/070583

§ 371 Date: Jun. 24, 2016

(30) Foreign Application Priority Data
Aug. 10, 2015 (CN) 201510487744.5

(51) Int. Cl. G05D 1/06; B64C 39/02

(52) U.S. Cl. CPC G05D 1/0676; G05D 1/0661; B64C 39/024; B64C 2201/108; B64C 2201/18

(57) ABSTRACT

A method and a device for flying and retrieving an unmanned aerial vehicle are provided. The method includes: detecting a state parameter of the unmanned aerial vehicle in real time; judging, based on the state parameter, whether the unmanned aerial vehicle is to be flown or to be retrieved in the handheld way; and controlling a rotor wing to rotate to take off, in a case of determining that the unmanned aerial vehicle is to be flown in the handheld way; or controlling the rotor wing to stop rotating, in a case of determining that the unmanned aerial vehicle is to be retrieved in the handheld way. With the method according to the present disclosure, a user can fly and retrieve the unmanned aerial vehicle without using a remote control device and the unmanned aerial vehicle becomes free from the control of other devices.

### CROSS REFERENCE OF RELATED APPLICATION

The present application claims priority to Chinese Patent Application No. 201510487744.5, titled “METHOD AND DEVICE FOR RETRIEVING AND FLYING UNMANNED AERIAL VEHICLE IN A HANDHELD WAY”, filed on Aug. 10, 2015 with the State Intellectual Property Office of People's Republic of China, which is incorporated herein by reference in its entirety.

### FIELD

The present disclosure relates to the technical field of unmanned aerial vehicle control, and in particular to a method and a device for retrieving and flying an unmanned aerial vehicle in a handheld way.

### BACKGROUND

In the conventional technology, an unmanned aerial vehicle is retrieved by controlling the unmanned aerial vehicle to fall to a certain plane using a remote controller and a similar remote control device such as a mobile phone, and then the unmanned aerial vehicle is retrieved manually.

In practice, in the conventional retrieving way, a user needs to operate the remote controller to control the unmanned aerial vehicle to fly above a landing point, which requires that the user has a certain level to operate the remote controller. If some users are not familiar with the remote control operation for the unmanned aerial vehicle, the unmanned aerial vehicle can not be retrieved quickly. In addition, in the retrieve way, the unmanned aerial vehicle undergoes a free fall with a certain distance before approaching a landing plane, which easily causes the unmanned aerial vehicle to be damaged. Finally, the retrieve way needs a strong manipulation with an unnatural human-machine interaction.

In the conventional technology, the unmanned aerial vehicle is flown in the following way:

a switch of the unmanned aerial vehicle is first switched on, the unmanned aerial vehicle is then placed on the ground or other planes, and a rotor wing of the unmanned aerial vehicle is finally controlled to rotate using the remote controller or a similar remote control device such as a mobile phone to fly the unmanned aerial vehicle.

The manner for flying the unmanned aerial vehicle using the remote controller requires that the user has skilled remote control skill with strong manipulation.

Hence, a method and a device for retrieving and flying an unmanned aerial vehicle in a handheld way are to be provided for those skilled in the art, which can retrieve the unmanned aerial vehicle in the handheld way without using the remote controller, and thereby achieving a better human-machine interaction.

### SUMMARY

The technical problem to be addressed by the present disclosure is to provide a method and a device for retrieving and flying an unmanned aerial vehicle in a handheld way, which can retrieve the unmanned aerial vehicle in the handheld way without using a remote controller, thereby achieving a better human-machine interaction.

A method for retrieving and flying an unmanned aerial vehicle in a handheld way is provided according to embodiments of the present disclosure, which includes:

detecting a state parameter of the unmanned aerial vehicle in real time;

judging, based on the state parameter, whether the unmanned aerial vehicle is to be flown or to be retrieved in the handheld way; and

controlling a rotor wing to rotate to take off, in a case of determining that the unmanned aerial vehicle is to be flown in the handheld way; or

controlling the rotor wing to stop rotating, in a case of determining that the unmanned aerial vehicle is to be retrieved in the handheld way.

Preferably, the determining that the unmanned aerial vehicle is to be retrieved in the handheld way may include:

judging, based on the state parameter of the unmanned aerial vehicle, whether the unmanned aerial vehicle is interfered by a hand; and determining that the unmanned aerial vehicle is to be retrieved in the handheld way in a case that it is determined that the unmanned aerial vehicle is interfered by the hand.

Preferably, the state parameter of the unmanned aerial vehicle may include a position parameter and an attitude parameter of the unmanned aerial vehicle, and the judging, based on the state parameter of the unmanned aerial vehicle, whether the unmanned aerial vehicle is interfered by the hand may include:

obtaining an amount of position change of the unmanned aerial vehicle from the position parameter of the unmanned aerial vehicle;

obtaining an amount of attitude change of the unmanned aerial vehicle from the attitude parameter of the unmanned aerial vehicle; and

determining that the unmanned aerial vehicle is interfered by the hand in a case that the amount of position change of the unmanned aerial vehicle is greater than or equal to a preset position change amount threshold and the amount of attitude change of the unmanned aerial vehicle is greater than or equal to a preset attitude change amount threshold.

Preferably, the determining that the unmanned aerial vehicle is to be flown in the handheld way may include:

judging whether the unmanned aerial vehicle is triggered to be in a flight standby state;

determining whether the unmanned aerial vehicle is in a handheld flat-laying state for a predetermine time period, in a case that it is determined that the unmanned aerial vehicle is in the flight standby state; and

judging whether the unmanned aerial vehicle is released by comparing the state parameter of the unmanned aerial vehicle with a state parameter thereof at a previous time instant, in a case that it is determined that the unmanned aerial vehicle is in the handheld flat-laying state; and determining that the unmanned aerial vehicle is to be flown in the handheld way if it is determined that the unmanned aerial vehicle is released.

Preferably, the judging whether the unmanned aerial vehicle is triggered to be in a flight standby state may include judging whether a motion trajectory along which the unmanned aerial vehicle is raised by the hand follows a preset trajectory, which may include:
detecting a position parameter (xᵢ, yᵢ, zᵢ) of the unmanned aerial vehicle at a time instant tᵢ, where xᵢ and yᵢ indicate two-dimensional coordinates on an x-axis and a y-axis in a horizontal plane parallel with the ground, zᵢ indicates a coordinate on a z-axis perpendicular to the ground, and tᵢ indicates a timestamp;

judging, based on xᵢ and yᵢ, whether components of the motion trajectory of the unmanned aerial vehicle along the x-axis and the y-axis extend monotonically along a positive direction or a negative direction of the x-axis and the y-axis respectively; judging, based on zᵢ, whether a component of the motion trajectory of the unmanned aerial vehicle along the z-axis extends monotonically along a positive direction of the z-axis; and

determining that the unmanned aerial vehicle is in the flight standby state, in a case that it is determined that the components of the motion trajectory of the unmanned aerial vehicle along the x-axis and the y-axis extend monotonically along the positive direction or the negative direction of the x-axis and the y-axis respectively and the component of the motion trajectory of the unmanned aerial vehicle along the z-axis extends monotonically along the positive direction of the z-axis.

Preferably, the determining that the unmanned aerial vehicle is in the handheld flat-laying state for the predetermine time period may include:

obtaining an amount of position change of the unmanned aerial vehicle from the position parameter of the unmanned aerial vehicle;

obtaining an amount of attitude change of the unmanned aerial vehicle from the attitude parameter of the unmanned aerial vehicle; and

determining that the unmanned aerial vehicle is in the handheld flat-laying state in a case that the amount of position change of the unmanned aerial vehicle is less than a preset position change amount threshold and the amount of attitude change of the unmanned aerial vehicle is less than a preset attitude change amount threshold.

A device for retrieving and flying an unmanned aerial vehicle in a handheld way is further provided according the embodiments of the present disclosure, the device includes a state parameter detecting unit, a judging unit and a control unit, where

the state parameter detecting unit is configured to detect a state parameter of the unmanned aerial vehicle in real time;

the judging unit is configured to judge, based on the state parameter, whether the unmanned aerial vehicle is to be flown or to be retrieved in a handheld way; and

the control unit is configured to control a rotor wing to rotate to take off in a case that it is determined by the judging unit that the unmanned aerial vehicle is to be flown in the handheld way, or control the rotor wing to stop rotating in a case that it is determined by the judging unit that the unmanned aerial vehicle is retrieved in the handheld way.

Preferably, the judging unit may be configured to judge, based on the state parameter of the unmanned aerial vehicle, whether the unmanned aerial vehicle is interfered by a hand, and determine that the unmanned aerial vehicle is to be retrieved in the handheld way in a case that it is determined that the unmanned aerial vehicle is interfered by the hand; and

the judging unit may include a position change amount obtaining subunit, an attitude change amount obtaining subunit and an interference judging subunit, where

the position change amount obtaining subunit may be configured to obtain an amount of position change of the unmanned aerial vehicle from the position parameter of the unmanned aerial vehicle;

the attitude change amount obtaining subunit may be configured to obtain an amount of attitude change of the unmanned aerial vehicle from the attitude parameter of the unmanned aerial vehicle; and

the interference judging subunit may be configured to determine that the unmanned aerial vehicle is interfered by the hand, in a case that the amount of position change of the unmanned aerial vehicle is greater than or equal to a preset position change amount threshold and the amount of attitude change of the unmanned aerial vehicle is greater than or equal to a preset attitude change amount threshold.

Preferably, the judging unit may be configured to determine that the unmanned aerial vehicle is triggered to be in a flight standby state in a case that a motion trajectory along which the unmanned aerial vehicle is raised by the hand follows a preset trajectory; determine whether the unmanned aerial vehicle is in a handheld flat-laying state for a predetermined time period, in a case that it is determined that the unmanned aerial vehicle is in the flight standby state, judge whether the unmanned aerial vehicle is released by comparing the state parameter of the unmanned aerial vehicle with a state parameter thereof at a previous time instant in a case that it is determined that the unmanned aerial vehicle is in the handheld flat-laying state; and determine that the unmanned aerial vehicle is to be flown in the handheld way if it is determined that the unmanned aerial vehicle is released.

Preferably, the judging unit may further include a position parameter detecting subunit, a first judging subunit and a first determining subunit, where

the position parameter detecting subunit is configured to detect a position parameter (xᵢ, yᵢ, zᵢ) of the unmanned aerial vehicle at a time instant tᵢ, where xᵢ and yᵢ indicate two-dimensional coordinates on an x-axis and a y-axis in a horizontal plane parallel with the ground, zᵢ indicates a coordinate perpendicular to the ground, and tᵢ indicates a time stamp;

the first judging subunit is configured to judge, based on xᵢ and yᵢ, whether components of the motion trajectory of the unmanned aerial vehicle along the x-axis and the y-axis extend monotonically along a positive direction or a negative direction of the x-axis and the y-axis respectively; and judge, based on zᵢ, whether a component of the motion trajectory of the unmanned aerial vehicle along the z-axis extends monotonically along a positive direction of the z-axis; and

the first determining subunit is configured to determine that the unmanned aerial vehicle is in the flight standby state, in a case that the first judging subunit determines that the components of the motion trajectory of the unmanned aerial vehicle along the x-axis and the y-axis extend monotonically along the positive direction or the negative direction of the x-axis and the y-axis respectively and the component of the motion trajectory of the unmanned aerial vehicle along the z-axis extends monotonically along the positive direction of the z-axis.

Preferably, the judging unit may further include a handheld flat-laying state judging subunit, where

the handheld flat-laying state judging subunit may be configured to determine that the unmanned aerial vehicle is in a handheld flat-laying state in a case that the amount of position change of the unmanned aerial vehicle is less than the preset position change amount threshold and the amount of attitude change of the unmanned aerial vehicle is less than the preset attitude change amount threshold.

As compared with the conventional technology, the present disclosure has the following advantages.

The state parameter of the unmanned aerial vehicle itself is detected; it is judged, based on the state parameter, whether the unmanned aerial vehicle is to be retrieved or to be flown in the handheld way; in a case that the unmanned aerial vehicle is to be retrieved in the handheld way, the unmanned aerial vehicle is subjected to a resistance from the hand, and the state parameter of the unmanned aerial vehicle changes obviously in a short time period during a flight process. In a case that the unmanned aerial vehicle is to be flown in the handheld way, the unmanned aerial vehicle is raised and during this process the sate parameter also changes, hence it may be judged whether the unmanned aerial vehicle is to be flown in the handheld way based on the change of the state parameter. According to the method provided by the present disclosure, the user does not need to fly and retrieve the unmanned aerial vehicle using a remote controller; a step of operating the remote controller is omitted for the user; and the unmanned aerial vehicle becomes free from the control of other devices, and it judges whether to be retrieved by the hand based on the collected parameter of the unmanned aerial vehicle. The method is easy to be implemented and the hardware cost of the remoter controller is saved.

### BRIEF DESCRIPTION OF THE DRAWINGS

In order to describe technical solutions in embodiments of the present disclosure or the conventional technology more clearly, drawings to be used in the description of the embodiments or the conventional technology are introduced simply. Apparently, the drawings described below only describe some embodiments of the present disclosure, and other drawings may be obtained based on these drawings by those skilled in the art without any creative work.

FIG. 1 is a flowchart of a first method embodiment for retrieving and flying an unmanned aerial vehicle in a handheld way according to the present disclosure;

FIG. 2 is a flowchart of a second method embodiment for retrieving an unmanned aerial vehicle in a handheld way according to the present disclosure;

FIG. 3 is a flowchart of a third method embodiment for flying an unmanned aerial vehicle in a handheld way according to the present disclosure;

FIG. 4 is a schematic diagram of a first device embodiment according to the present disclosure; and

FIG. 5 is a schematic diagram of a judging unit according to present disclosure.

### DETAILED DESCRIPTION OF THE EMBODIMENTS

Hereinafter technical solutions of embodiments of the present disclosure are described clearly and completely in conjunction with the drawings of the embodiments of the present disclosure. Apparently, the described embodiments are only some rather than all of the embodiments of the present disclosure. Any other embodiments obtained based on the embodiments of the present disclosure by those skilled in the art without any creative work fall within the scope of protection of the present disclosure.

In order to make the objects, features and advantages of the present disclosure become more obvious and easier to be understood, specific embodiments of the present disclosure are described in detail in conjunction with the drawings.

### First Method Embodiment

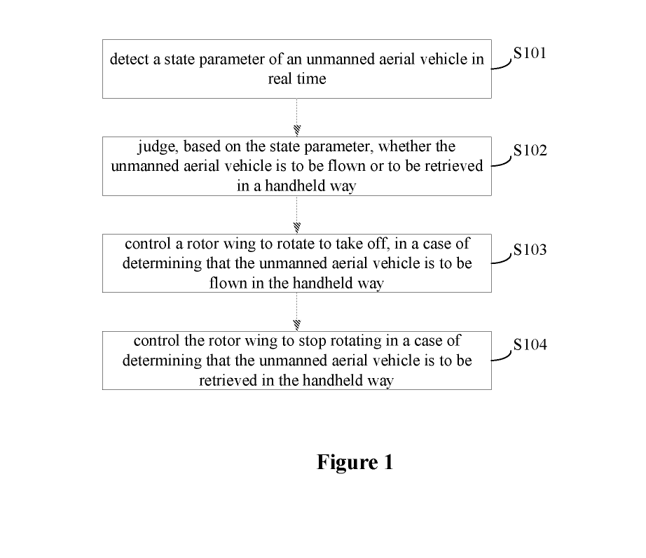

FIG. 1 is a flowchart of a first method embodiment for retrieving and flying an unmanned aerial vehicle in a handheld way according to the present disclosure.

The method for retrieving and flying the unmanned aerial vehicle in a handheld way according to the embodiment includes step S101 to step S104.

In step S101, a state parameter of the unmanned aerial vehicle is detected in a real time.

It should be understood that, with the method for retrieving and flying the unmanned aerial vehicle according to the present disclosure, no remote controller is used and the unmanned aerial vehicle is retrieved directly by hand. Hence, the state parameter of the unmanned aerial vehicle is detected by sensors provided on the unmanned aerial vehicle itself. For example, an accelerometer and a gyroscope and so on are provided on the unmanned aerial vehicle.

In step S102, it is judged, based on the state parameter, whether the unmanned aerial vehicle is to be flown or to be retrieved in a handheld way.

The determining that the unmanned aerial vehicle is to be retrieved in the handheld way may include:

judging, based on the state parameter of the unmanned aerial vehicle, whether the unmanned aerial vehicle is interfered by a hand; and determining that the unmanned aerial vehicle is to be retrieved in the handheld way if it is determined that the unmanned aerial vehicle is interfered by the hand.

It should be understood that, in a case that the unmanned aerial vehicle is to be retrieved in the handheld way, the unmanned aerial vehicle is subjected to a resistance from the hand, and the state parameter changes obviously in a short time period.

In a case that the unmanned aerial vehicle is to be flown in the handheld way, the unmanned aerial vehicle is subjected to an uplift force from the hand and then is triggered to take off.

In step S103, a rotor wing is controlled to rotate to take off in a case that it is determined that the unmanned aerial vehicle is to be flown in the handheld way.

It should be noted that, in the present disclosure, flying in the handheld way refers to that the unmanned aerial vehicle can maintain a hovering state in the air after the unmanned aerial vehicle is released from the hand. It should be understood that, in a case that the unmanned aerial vehicle is in the hovering state, a speed is zero and an angular speed is also zero.

In step S104, the rotor wing is controlled to stop rotating in a case that it is determined that the unmanned aerial vehicle is to be retrieved in the handheld way.

With the method for retrieving and flying the unmanned aerial vehicle in a handheld way according to the present disclosure, it can be judged whether the unmanned aerial vehicle is to be retrieved or to be flown in the handheld way by detecting the state parameter of the unmanned aerial vehicle itself, in a case that the unmanned aerial vehicle is to be retrieved in the handheld way, the unmanned aerial vehicle is subjected to a resistance from the hand so that the state parameter of the unmanned aerial vehicle changes obviously in a short time period during a flight process. In a case that the unmanned aerial vehicle is to be flown in the handheld way, the unmanned aerial vehicle is raised and during this process the sate parameter also changes, hence it may be judged whether the unmanned aerial vehicle is to be flown in the handheld way based on the change of the state parameter. According to the method provided by the present disclosure, the user does not need to fly and retrieve the unmanned aerial vehicle using a remote controller; the step of operating the remote controller is omitted for the user, and the unmanned aerial vehicle becomes free from the control of other devices, and it judges whether to be retrieved by the hand based on the collected parameter of the unmanned aerial vehicle. The method is easy to be implemented and the hardware cost of the remoter controller is saved.

In addition, it should be noted that, to ensure safety, the method for retrieving in the handheld way according to the present disclosure is generally applied to an unmanned aerial vehicle in which the rotor wing is arranged inside the housing, i.e., the housing is arranged outside the rotor wing; and in this case, the rotating rotor wing does not hurt the hand during a process that the unmanned aerial vehicle is retrieved and flown in the handheld way.

### Second Method Embodiment

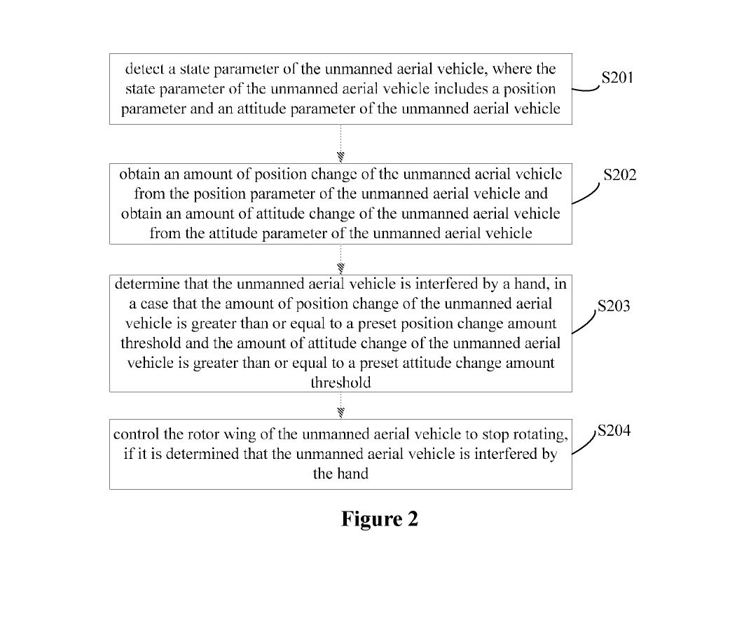

FIG. 2 is a flowchart of a process for retrieving an unmanned aerial vehicle in a handheld way according to the present disclosure.

In step S201, a state parameter of the unmanned aerial vehicle is detected in real time, where the state parameter of the unmanned aerial vehicle includes a position parameter and an attitude parameter of the unmanned aerial vehicle.

The position parameter of the unmanned aerial vehicle is obtained by merging data detected by an accelerometer, data of the unmanned aerial vehicle relative to the ground feature point detected by a first camera arranged in a side of the unmanned aerial vehicle facing the ground, and data of a distance between the unmanned aerial vehicle and the ground detected by a sonar detector.

The attitude parameter of the unmanned aerial vehicle is obtained by merging data detected by the accelerometer and data detected by a gyroscope.

It is assumed that the state parameter of the unmanned aerial vehicle is indicated as (tᵢ, xᵢ, yᵢ, zᵢ, Φᵢ, θᵢ, ψᵢ), wherein, (xᵢ, yᵢ, zᵢ) indicates a position parameter of the unmanned aerial vehicle at a time instant tᵢ, xᵢ and yᵢ indicate two-dimensional coordinates on a x-axis and a y-axis in a horizontal plane parallel with the ground, zᵢ indicates a coordinate on a z-axis perpendicular to the ground, and tᵢ indicates a timestamp; (Φᵢ, θᵢ, ψᵢ) indicates an attitude parameter of the unmanned aerial vehicle at the time instant tᵢ, i.e., Φᵢ, θᵢ, and ψᵢ indicate angles relative to the three axes above respectively.

In step S202, an amount of position change of the unmanned aerial vehicle is obtained from the position parameter of the unmanned aerial vehicle, and an amount of attitude change of the unmanned aerial vehicle is obtained from the attitude parameter of the unmanned aerial vehicle.

The amount of position change of the unmanned aerial vehicle Vₜ_{ᵢ}^{P} is obtained from the position parameter of the unmanned aerial vehicle using the following formula:

Vₜ_{ᵢ}^{P}=|dxᵢ|+|dyᵢ|+|dxᵢ|;

the amount of attitude change of the unmanned aerial vehicle Vₜ_{ᵢ}^{O} is obtained from the attitude parameter of the unmanned aerial vehicle using the following formula:

Vₜ_{ᵢ}^{O}=|dφᵢ|+|dθᵢ|+|dψᵢ|.

In step S203, it is determined that the unmanned aerial vehicle is interfered by the hand, in a case that the amount of position change of the unmanned aerial vehicle is greater than or equal to a preset position change amount threshold and the amount of attitude change of the unmanned aerial vehicle is greater than or equal to a preset attitude change amount threshold.

Furthermore, the following formula is given, in which t indicates a time instant when the rotation of the rotor wing is stopped. Specifically, if a condition shown in the following formula is met during a time period from tₐ to t_{b} before the time instant t, the rotor wing may be controlled to stop rotating at the time instant t.

t={Cₜ_{ᵢ}^{P}≧thrₚ&Cₜ_{ᵢ}^{O}≧thr_{O}}.

In which,

$${C}_{{t}_{i}}^{P} = {{{max}_{i = α}}^{b}}^{{V}_{{t}_{i}}^{P}} , {C}_{{t}_{i}}^{o} = {{{max}_{i = α}}^{b}}^{{V}_{{t}_{i}}^{o}} ,$$

t is after t_{b}, and the rotor wing is controlled to stop rotating at the time instant t.

That is, the rotor wing may be controlled to stop rotating at a time instant after t_{b}, in a case that a maximum value of the amount of the position change Vₜ_{ᵢ}^{P} during the time period from tₐ to t_{b} is greater than or equal to the preset position change amount threshold thrₚ and a maximum value of the attitude change is greater than or equal to the preset attitude change amount threshold thrₒ.

It should be understood that, the time instant after t_{b} for controlling the rotor wing to stop rotating may refer to any time instant after t_{b}, and in order to control the rotor wing to stop rotating as fast as possible, the rotor wing is controlled to stop rotating at the earliest time instant once the rotation stopping condition for the rotor wing is met.

For example, a time window for judgment is indicated by T, and a length of T is T=t_{b}−tₐ. If it is determined that the rotation stopping condition for the rotor wing is met during a first time window and the rotation stopping condition for the rotor wing is also met during a second time window, the rotor wing may be controlled to stop rotating at a time instant after the first time window and it is not necessary to judge the second time window.

In step S204, the rotor wing of the unmanned aerial vehicle is controlled to stop rotating if it is determined that the unmanned aerial vehicle is interfered by the hand.

In the embodiment, it is judged whether the unmanned aerial vehicle is interfered by the hand, i.e., being subjected to a resistance from the hand, by judging whether the amount of position change and the amount of attitude change of the unmanned aerial vehicle meet the set conditions. In a case that the conditions are met, it is indicated that the unmanned aerial vehicle is subjected to the resistance from the hand and the user is retrieving the unmanned aerial vehicle in the handheld way; and accordingly, the unmanned aerial vehicle controls its rotor wing to stop rotating, thereby retrieving the unmanned aerial vehicle in the handheld way.

In addition, it should be noted that, to ensure safety, the method for retrieving the unmanned aerial vehicle in the handheld way according to the present disclosure is generally applied to an unmanned aerial vehicle in which the rotor wing is arranged inside the housing, i.e., the housing is arranged outside the rotor wing; and in this case, the rotating rotor wing does not hurt the hand during a process that the unmanned aerial vehicle is retrieved in the handheld way.

With the method for retrieving the unmanned aerial vehicle in the handheld way according to the embodiment, an operator does not need to operate the remote controller, and no requirement is applied to the operation skill of the operator. For the unmanned aerial vehicle, there is no free falling process, which protects the unmanned aerial vehicle from being damaged. For example, in the conventional technology, the unmanned aerial vehicle is retrieved in the following way. The unmanned aerial vehicle is controlled to fly above the operator by the remote controller, and then the unmanned aerial vehicle freely falls into the hand of the operator to be retrieved. The conventional way for retrieving the unmanned aerial vehicle using the remote controller has poor controllability.

### Third Method Embodiment

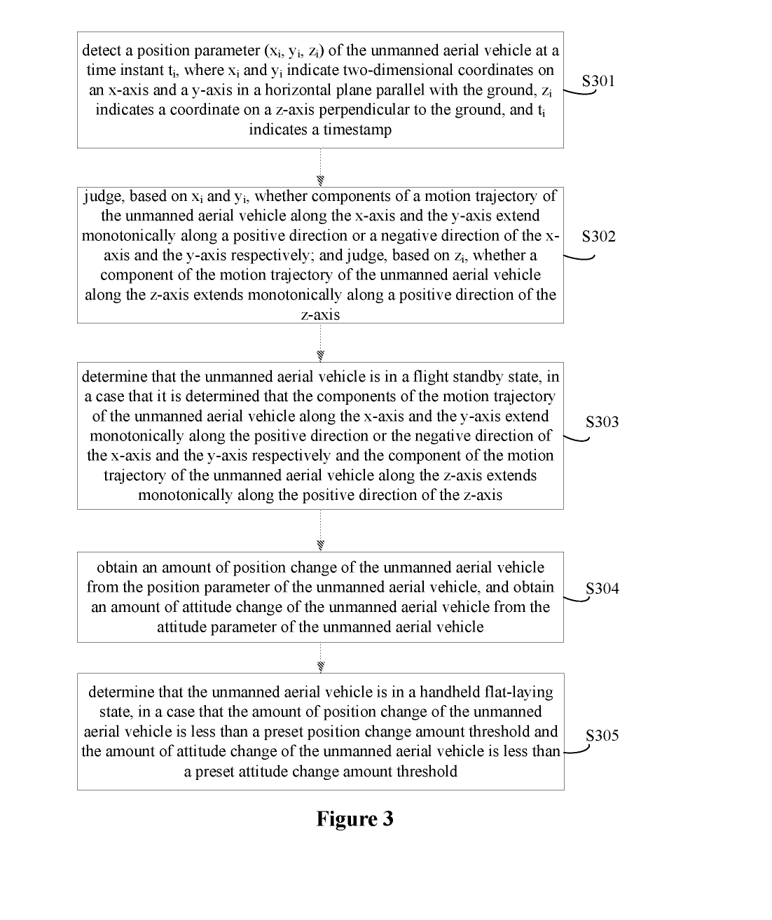

FIG. 3 is a flowchart of a process for flying an unmanned aerial vehicle in a handheld way according to the present disclosure.

In the embodiment, whether to be triggered to be in a flight standby state may be judged by judging whether a motion trajectory along which the unmanned aerial vehicle is raised by a hand follows a preset trajectory.

The judging whether the unmanned aerial vehicle is triggered to be in the flight standby state by judging whether the motion trajectory along which the unmanned aerial vehicle is raised by a hand follows a preset trajectory may include step S301 to step S305.

In step S301, a position parameter (xᵢ, yᵢ, zᵢ) of the unmanned aerial vehicle at a time instant tᵢ is detected, where xᵢ and yᵢ indicate two-dimensional coordinates on an x-axis and a y-axis in a horizontal plane parallel with the ground, zᵢ indicates a coordinate on a z-axis perpendicular to the ground, and tᵢ indicates a timestamp.

In step S302, it is judged, based on xᵢ and yᵢ, whether components of a motion trajectory of the unmanned aerial vehicle along the x-axis and the y-axis extends monotonically along a positive direction or a negative direction of the x-axis and the y-axis respectively; and it is judged, based on zᵢ, whether a component of a motion trajectory of the unmanned aerial vehicle along a z-axis extends monotonically along a positive direction of the z-axis.

In step S303, it is determined that the unmanned aerial vehicle is in the flight standby state, in a case that it is determined that the components of the motion trajectory of the unmanned aerial vehicle along the x-axis and the y-axis extends monotonically along the positive direction or the negative direction of the x-axis and the y-axis respectively and the component of the motion trajectory of the unmanned aerial vehicle along the z-axis extends monotonically along the positive direction of the z-axis.

It is assumed that the motion trajectory along which the unmanned aerial vehicle is raised by the hand is a parabola in a three-dimensional space, and a relationship between the position parameter and time instant is given by the following formula (1):

$$\{ \begin{matrix}{x}_{i} = {α}_{1} {t}_{i} + {β}_{1} \\ {y}_{i} = {α}_{2} {t}_{i} + {β}_{2} \\ {z}_{i} = {α}_{3} ( {x}_{i}^{2} + {y}_{i}^{2} )\end{matrix} \qquad ( 1 )$$

where, α3>0, α1, α2, β1 and β2 each are set coefficients.

Speeds of the unmanned aerial vehicle along the x-axis, y-axis and z-axis may be obtained from the formula (1), as shown in the following formula (2):

$$\{ \begin{matrix}\frac{d {x}_{i}}{d {t}_{i}} = {α}_{1} \\ \frac{d {y}_{i}}{d {t}_{i}} = {α}_{2} \\ \frac{{d}^{2} {z}_{i}}{d {t}_{i}^{2}} = 2 {α}_{3} ( {α}_{1}^{2} + {α}_{2}^{2} ) > 0\end{matrix} \qquad ( 2 )$$

It may be known from the formula (2) that, during a process that the unmanned aerial vehicle is raised, motions in horizontal directions, i.e., directions of the x-axis and the y-axis, are monotonic, and a motion along the z-axis is monotonic along the positive direction of the z-axis, i.e., rising along the z-axis.

In practice, the above formulas may not be followed strictly during the process the unmanned aerial vehicle is raised, the unmanned aerial vehicle may vibrate or fluctuate temporarily, hence the judging condition is relaxed in order to take the vibration into consideration. It should be understood that, in a case that the unmanned aerial vehicle moves along the positive direction or the negative direction of the x-axis all the time,

$$\vert \sum \frac{d {x}_{i}}{d {t}_{i}} \vert = \sum \vert \frac{d {x}_{i}}{d {t}_{i}} \vert .$$

If the unmanned aerial vehicle fluctuates during moving along the x-axis,

$$\vert \sum \frac{d {x}_{i}}{d {t}_{i}} \vert < \sum \vert \frac{d {x}_{i}}{d {t}_{i}} \vert .$$

For the fluctuation case, a tolerated threshold T₁ is set in order not to influence the final determination. Similarly, a tolerated threshold T₁ is set for the y-axis, and a tolerated threshold T₂ is set for the z-axis. It may be judged according to the following formulas (4), (5) and (6).

The judging, based on xᵢ, whether the component of the motion trajectory of the unmanned aerial vehicle along the x-axis extends monotonically along the positive direction or the negative direction of the x-axis may be implemented according to the following formula:

$$\vert \sum \frac{d {x}_{i}}{d {t}_{i}} \vert \geq {T}_{1} \sum \vert \frac{d {x}_{i}}{d {t}_{i}} \vert . \qquad ( 4 )$$

The judging, based on yᵢ, whether the component of the motion trajectory of the unmanned aerial vehicle along the y-axis extends monotonically along the positive direction or the negative direction of the y-axis may be implemented according to the following formula:

$$\vert \sum \frac{d {y}_{i}}{d {t}_{i}} \vert \geq {T}_{1} \sum \vert \frac{d {y}_{i}}{d {t}_{i}} \vert . \qquad ( 5 )$$

The judging, based on zᵢ, whether the component of the motion trajectory of the unmanned aerial vehicle along the z-axis extends monotonically along the positive direction of the z-axis may be implemented according to the following formula:

$$\sum \frac{d {z}_{i}}{d {t}_{i}} \geq {T}_{2} \sum \vert \frac{d {z}_{i}}{d {t}_{i}} \vert . \qquad ( 6 )$$

Wherein, T₁ is a preset value greater than 0 and less than or equal to 1, and T₂ is a preset value greater than 0 and less than or equal to 1.

If the motions of the unmanned aerial vehicle along the x-axis, the y-axis and the z-axis meets the formulas (4), (5) and (6), it may be determined that the unmanned aerial vehicle is triggered to be in a flight standby state.

In step S304, an amount of position change of the unmanned aerial vehicle is obtained from the position parameter of the unmanned aerial vehicle, and an amount of attitude change of the unmanned aerial vehicle is obtained from the attitude parameter of the unmanned aerial vehicle.

In step S305, it is determined that the unmanned aerial vehicle is in a handheld flat-laying state, in a case that the amount of position change of the unmanned aerial vehicle is less than the preset position change amount threshold and the amount of attitude change of the unmanned aerial vehicle is less than the preset attitude change amount threshold.

It should be noted that, in the embodiment, the unmanned aerial vehicle determines that it is in a handled flat-laying state based on a resistance from the hand. The judging whether the unmanned aerial vehicle is in a handheld flat-laying state may be implemented by the following method.

It is assumed that the position parameter of the unmanned aerial vehicle is indicated as (tᵢ, xᵢ, yᵢ, zᵢ, Φᵢ, θᵢ, ψᵢ), wherein, (xᵢ, yᵢ, zᵢ) indicates a position parameter of the unmanned aerial vehicle at a time instant tᵢ, xᵢ and yᵢ indicate two-dimensional coordinates on an x-axis and a y-axis on a horizontal plane parallel with the ground, zᵢ indicates a coordinate on a z-axis perpendicular to the ground, and tᵢ indicates a timestamp; (Φᵢ, Φᵢ, ψᵢ) indicates an attitude parameter at the time instant tᵢ, i.e., Φᵢ, θᵢ, and ψᵢ indicate angles between the unmanned aerial vehicle and the three axes above respectively.

The amount of position change of the unmanned aerial vehicle Vₜ_{ᵢ}^{P} is obtained from the position parameter of the unmanned aerial vehicle using the following formula:

Vₜ_{ᵢ}^{P}=|dxᵢ|+|dyᵢ|+|dzᵢ|.

The amount of attitude change of the unmanned aerial vehicle Vₜ_{ᵢ}^{O} is obtained from the attitude parameter of the unmanned aerial vehicle using the following formula:

Vₜ_{ᵢ}^{O}=|dφᵢ|+|dθᵢ|+|dψᵢ|.

It is determined that the unmanned aerial vehicle is interfered by the hand, in a case that the amount of position change of the unmanned aerial vehicle is less than the preset position change amount threshold and the amount of attitude change of the unmanned aerial vehicle is less than the preset attitude change amount threshold.

Furthermore, the following formula is given, in which t indicates a time instant when the rotation of the rotor wing is stopped. Specifically, if a condition shown in the following formula is met during a time period from tₐ to t_{b} before the time instant t, the rotor wing may be controlled to stop rotating at the time instant t.

t={Cₜ_{ᵢ}^{P}<thrₚ&Cₜ_{ᵢ}^{O}<thr_{O}}.

In which,

$${C}_{{t}_{i}}^{P} = {{{max}_{i = α}}^{b}}^{{V}_{{t}_{i}}^{P}} , {C}_{{t}_{i}}^{o} = {{{max}_{i = α}}^{b}}^{{V}_{{t}_{i}}^{o}} ,$$

t is after t_{b}, and the rotor wing is controlled to stop rotating at the time instant t.

That is, the rotor wing may be controlled to stop rotating at a time instant after t_{b}, in a case that a maximum value of the amount of the position change Vₜ_{ᵢ}^{P} during the time period from tₐ to t_{b} is less than a position change amount threshold thrₚ and a maximum value of the amount of the attitude change is less than an attitude change amount threshold thrₒ.

It should be understood that, the time instant after t_{b} for controlling the rotor wing to stop rotating may refer to any time instant after t_{b}, and in order to control the rotor wing to stop rotating as fast as possible, the rotor wing is controlled to stop rotating at the earliest time instant once the rotation stopping condition for the rotor wing is met.

For example, a time window for judgment is indicated by T, and a length of T is T=t_{b}−tₐ. If it is determined that the rotation stopping condition for the rotor wing is met during a first time window and the rotation stopping condition for the rotor wing is also met during a second time window, the rotor wing may be controlled to stop rotating at a time instant after the first time window and it is not necessary to judge the second time window.

In step S306, it is judged whether the unmanned aerial vehicle is released from the hand by comparing the state parameter of the unmanned aerial vehicle itself with a state parameter thereof at a previous time instant, in a case that it is determined that the unmanned aerial vehicle is in the handheld flat-laying state; and the rotor wing of the unmanned aerial vehicle is controlled to rotate to take off if it is determined that the unmanned aerial vehicle is released from the hand.

In a case that the unmanned aerial vehicle is in the handheld flat-laying state for a predetermined time period, a position of the unmanned aerial vehicle at the current time instant is determined as an initial position. It should be noted that, in a case that the unmanned aerial vehicle is in the handheld flat-laying state, a speed and an angular speed each are zero. When the unmanned aerial vehicle is released from the hand, the unmanned aerial vehicle needs to complete a self-adaptation process to hover in the air stably. In practice, in the time instant when the unmanned aerial vehicle is released from the hand, the unmanned aerial vehicle needs to adjust its attitude to be in the initial position. Hence, various types of sensors provided in the unmanned aerial vehicle detect a state of the unmanned aerial vehicle, compare the current state with the state at the initial position, and control the speed, the angular speed, an acceleration of the unmanned aerial vehicle and so on based on a comparing result, such that the unmanned aerial vehicle can hover in the air stably after the unmanned aerial vehicle is released from the hand, i.e., maintaining the same sate as that at the initial position.

Based on the method for retrieving and flying the unmanned aerial vehicle in a handheld way according to the above embodiments, a device for retrieving and flying the unmanned aerial vehicle in a handheld way is further provided according to the present disclosure. Hereinafter an operation principle of the device is described in detail in conjunction with the drawings.

### First Device Embodiment

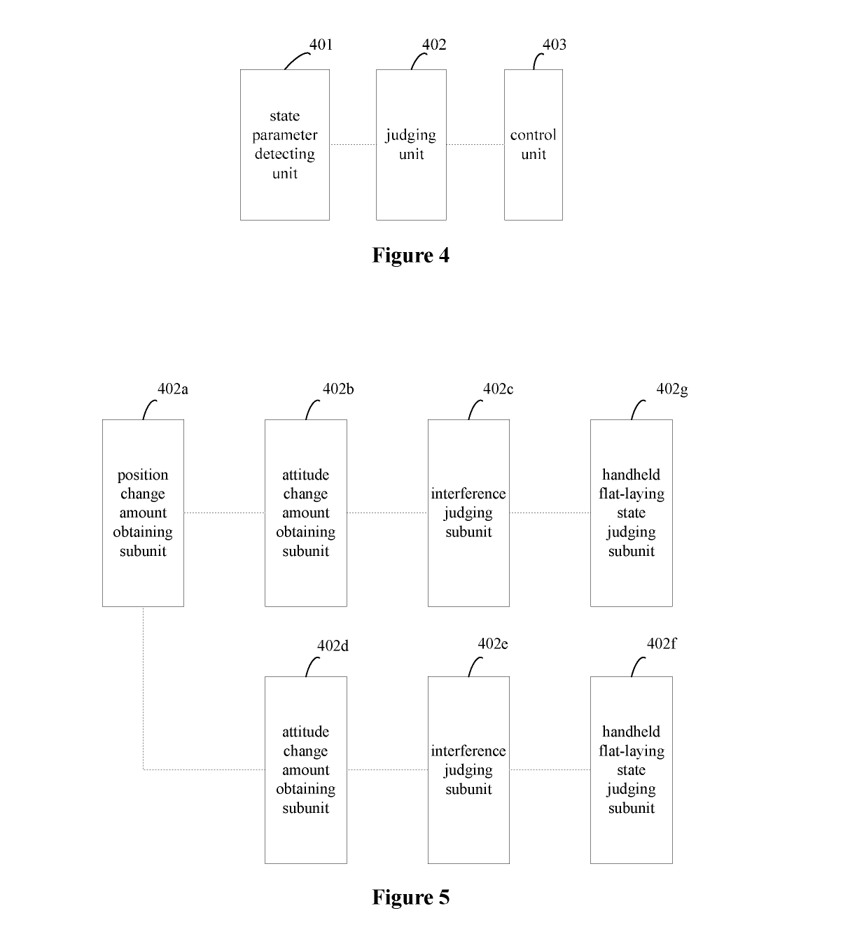

FIG. 4 is a schematic diagram of a first device embodiment according to the present disclosure.

The device for retrieving and flying an unmanned aerial vehicle in a handheld way according to the embodiment includes a state parameter detecting unit 401, a judging unit 402 and a control unit 403.

The state parameter detecting unit 401 is configured to detect a state parameter of the unmanned aerial vehicle in real time.

It may be understood that, with the method for retrieving the unmanned aerial vehicle in the handheld way according to the present disclosure, no remote controller is used and the unmanned aerial vehicle is retrieved directly by hand. Hence, the state parameter of the unmanned aerial vehicle is detected by sensors provided in the unmanned aerial vehicle. For example, an accelerometer and a gyroscope and so on are provided in the unmanned aerial vehicle.

The judging unit 402 is configured to judge, based on the state parameter, whether the unmanned aerial vehicle is to be flown or to be retrieved in a handheld way.

The operation for determining that the unmanned aerial vehicle is to be retrieved in the handheld way may include:

judging, based on the state parameter of the unmanned aerial vehicle, whether the unmanned aerial vehicle is interfered by the hand; and determine that the unmanned aerial vehicle is to be retrieved in the handheld way if it is determined that the unmanned aerial vehicle is interfered by the hand.

It should be understood that, in a case that the unmanned aerial vehicle is to be retrieved in the handheld way, the unmanned aerial vehicle is subjected to a resistance from the hand, and the state parameter changes obviously during a short time period.

In a case that the unmanned aerial vehicle is to be flown in the handheld way, the unmanned aerial vehicle is subjected to an uplift force from the hand and then is triggered to take off.

The control unit 403 is configured to control a rotor wing to rotate to take off if the judging unit 402 determines that the unmanned aerial vehicle is to be flown in the handheld way; or control the rotor wing to stop rotating if the judging unit 402 determines that the unmanned aerial vehicle is to be retrieved in the handheld way.

With the device for retrieving and flying the unmanned aerial vehicle in a handheld way according to the present disclosure, the state parameter of the unmanned aerial vehicle itself is detected; it is judged, based on the state parameter, whether the unmanned aerial vehicle is to be retrieved or to be flown in the handheld way; in a case that the unmanned aerial vehicle is to be retrieved in the handheld way, the unmanned aerial vehicle is subjected to a resistance from the hand, and the state parameter of the unmanned aerial vehicle changes obviously in a short time period during a flight process. In a case that the unmanned aerial vehicle is to be flown in the handheld way, the unmanned aerial vehicle is raised and during this process the sate parameter also changes, hence it may be judged whether the unmanned aerial vehicle is to be flown in the handheld way based on the change of the state parameter. With the device provided by the present disclosure, the user does not need to fly and retrieve the unmanned aerial vehicle using a remote controller; the step of operating the remote controller is omitted for the user, and the unmanned aerial vehicle becomes free from the control of other devices, and it judges whether to be retrieved by hand based on the collected parameter of the unmanned aerial vehicle. The device is easy to be implemented and the hardware cost of the remoter controller is saved.

### Second Device Embodiment

FIG. 5 is a schematic diagram of the judging unit in the device according to the present disclosure.

With the device according to the embodiment, the judging unit judges, based on the state parameter of the unmanned aerial vehicle, whether the unmanned aerial vehicle is interfered by the hand; and determines that the unmanned aerial vehicle is to be retrieved in the handheld way if it is determined that the unmanned aerial vehicle is interfered by the hand.

The judging unit 402 includes a position change amount obtaining subunit 402a, an attitude change amount obtaining subunit 402b and an interference judging subunit 402c.

The position change amount obtaining subunit 402a is configured to obtain an amount of position change of the unmanned aerial vehicle from the position parameter of the unmanned aerial vehicle.

The attitude change amount obtaining subunit 402b is configured to obtain an amount of attitude change of the unmanned aerial vehicle from the attitude parameter of the unmanned aerial vehicle.

The interference judging subunit 402c is configured to determine that the unmanned aerial vehicle is interfered by the hand, in a case that the amount of position change of the unmanned aerial vehicle is greater than or equal to a preset position change amount threshold and the amount of attitude change of the unmanned aerial vehicle is greater than or equal to a preset attitude change amount threshold.

The position change amount obtaining subunit 402a obtains the amount of position change of the unmanned aerial vehicle Vₜ_{ᵢ}^{P} using the following formula:

Vₜ_{ᵢ}^{P}=|dxᵢ|+|dyᵢ|+|dzᵢ|.

In which, (xᵢ, yᵢ, zᵢ) indicates a position parameter at a time instant tᵢ, xᵢ and yᵢ indicate two-dimensional coordinates on an x-axis and a y-axis on a horizontal plane parallel to the ground, and zᵢ indicates a coordinate on a z-axis perpendicular to the ground.

The attitude change amount obtaining subunit 402b obtains the amount of attitude change of the unmanned aerial vehicle Vₜ_{ᵢ}^{O} using the following formula:

Vₜ_{ᵢ}^{O}=|dφᵢ|+|dθᵢ|+|dψᵢ|,

where (Φᵢ, θᵢ, ψᵢ) indicates an attitude parameter of the unmanned aerial vehicle at the time instant tᵢ.

The interference judging subunit 402c is configured to determine that the unmanned aerial vehicle is interfered by the hand, in a case that within a predetermined time window (tₐ, t_{b}), a maximum value of the amount of position change is greater than or equal to the preset position change amount threshold and a maximum value of the amount of attitude change is greater than or equal to the preset attitude change amount threshold.

Furthermore, the interference judging subunit 402c may make a judgment using the following formula. Herein, t indicates a time instant when the rotation of the rotor wing is stopped. Specifically, if a condition shown in the following formula is met during a time period from tₐ to t_{b} before the time instant t, the rotor wing may be controlled to stop rotating at the time instant t.

t={Cₜ_{ᵢ}^{P}≧thr_{P}&Cₜ_{ᵢ}^{O}≧thr_{O}};

In which,

$${C}_{{t}_{i}}^{P} = {{{max}_{i = α}}^{b}}^{{V}_{{t}_{i}}^{P}} , {C}_{{t}_{i}}^{o} = {{{max}_{i = α}}^{b}}^{{V}_{{t}_{i}}^{o}} ,$$

t is after t_{b}, and the rotor wing is controlled to stop rotating at the time instant t.

That is, the rotor wing may be controlled to stop rotating at a time instant after t_{b}, in a case that the maximum value of the amount of the position change Vₜ_{ᵢ}^{P} during the time period from tₐ to t_{b} is greater than or equal to the preset position change amount threshold thrₚ and the maximum value of the amount of the attitude change is greater than or equal to the preset attitude change amount threshold thrₒ.

It should be understood that, the time instant after t_{b} for controlling the rotor wing to stop rotating may refer to any time instant after t_{b}, and in order to control the rotor wing to stop rotating as fast as possible, the rotor wing is controlled to stop rotating at the earliest time instant once the rotation stopping condition for the rotor wing is met.

For example, a time window for judgment is indicated by T, and a length of T is T=t_{b}−tₐ. If it is determined that the rotation stopping condition for the rotor wing is met during a first time window and the rotation stopping condition for the rotor wing is also met during a second time window, the rotor wing may be controlled to stop rotating at a time instant after the first time window and it is not necessary to judge the second time window.

The judging unit 402 in the embodiment determines that the unmanned aerial vehicle is triggered to be in a flight standby state in a case that the motion trajectory along which the unmanned aerial vehicle is raised follows a preset trajectory; and determines whether the unmanned aerial vehicle is in a handheld flat-laying state in a predetermined time period, in a case that it is determined that the unmanned aerial vehicle is in the flight standby state; judges whether the unmanned aerial vehicle is released from the hand by comparing the state parameter of the unmanned aerial vehicle with a state parameter thereof at a previous time instant, in a case that it is determined that the unmanned aerial vehicle is in the handheld flat-laying state; and determine that the unmanned aerial vehicle is to be flown in the handheld way if it is determined that the unmanned aerial vehicle is released from the hand.

The judging unit 402 further includes a position parameter detecting subunit 402d, a first judging subunit 402e and a first determining subunit 402f.

The position parameter detecting subunit 402d is configured to detect a position parameter (xᵢ, yᵢ, zᵢ) of the unmanned aerial vehicle at a time instant tᵢ, where xᵢ and yᵢ indicate two-dimensional coordinates on an x-axis and a y-axis in a horizontal plane parallel with the ground, zᵢ indicates a coordinate on a z-axis perpendicular to the ground, and tᵢ indicates a timestamp.

The first judging subunit 402e is configured to judge, based on xᵢ and yᵢ, whether components of a motion trajectory of the unmanned aerial vehicle along the x-axis and the y-axis extends monotonically along a positive direction or a negative direction of the x-axis and the y-axis respectively; and judge, based on zᵢ, whether a component of a motion trajectory of the unmanned aerial vehicle along a z-axis extends monotonically along a positive direction of the z-axis.

The first determining subunit 402f is configured to determine that the unmanned aerial vehicle is in the flight standby state, in a case that the first judging subunit 402e determines that the components of the motion trajectory of the unmanned aerial vehicle along the x-axis and the y-axis extend monotonically along the positive direction or the negative direction of the x-axis and the y-axis respectively and the component of the motion trajectory of the unmanned aerial vehicle along the z-axis extends monotonically along the positive direction of the z-axis.

The judging subunit 402 further includes a handheld flat-laying state judging subunit 403g.

The handheld flat-laying state judging subunit 402g is configured to determine that the unmanned aerial vehicle is in the handheld flat-laying state, in a case that the amount of position change of the unmanned aerial vehicle is less than the preset position change amount threshold and the amount of attitude change of the unmanned aerial vehicle is less than the preset attitude change amount threshold.

In a case that the unmanned aerial vehicle is in the handheld flat-laying state for a predetermined time instant, a position of the unmanned aerial vehicle at the time instant is determined as an initial position. It should be noted that, in a case that the unmanned aerial vehicle is in the handheld flat-laying state, a speed and an angular speed each are zero. When the unmanned aerial vehicle is released from the hand, the unmanned aerial vehicle needs to complete a self-adaptation process such that the unmanned aerial vehicle may hover in the air stably. At the time instant at which the unmanned aerial vehicle is released from the hand, the unmanned aerial vehicle needs to adjust its attitude to be in the initial position. Hence, various types of sensors provided in the unmanned aerial vehicle detect a state of the unmanned aerial vehicle, compare the current state with the state at the initial position, and control the speed, the angular speed, an acceleration of the unmanned aerial vehicle and so on based on a comparing result, such that the unmanned aerial vehicle can hover in the air stably after the unmanned aerial vehicle is released from the hand, i.e., maintaining the same sate as that at the initial position.

The unmanned aerial vehicle according to the embodiments of the present disclosure may be flown in the handheld way; and it is not necessary to use the remote controller to fly the unmanned aerial vehicle, and the user directly flies the unmanned aerial vehicle in the handheld way. When the unmanned aerial vehicle is released from the hand, the unmanned aerial vehicle can complete a self-adaptation process to take off. In this way, the unmanned aerial vehicle can be controlled more freely, and the user can fly the unmanned aerial vehicle easily even if the user is not familiar with the remote control skill.

What is described above is only preferred embodiments of the present disclosure and is not intended to limit the present disclosure in any way. The preferred embodiments of the present disclosure are disclosed above, which should not be interpreted as limiting the present disclosure. Numerous alternations, modifications and equivalents can be made to the technical solutions of the present disclosure by those skilled in the art in light of the methods and technical contents disclosed herein without departing from the scope of the present disclosure. Therefore, any alternations, modifications and equivalents made to the embodiments above according to the technical essence of the present disclosure without departing from the scope of the present disclosure should fall within the scope of protection of the present disclosure.

1. A method for flying and retrieving an unmanned aerial vehicle in a handheld way, comprising:
detecting a state parameter of the unmanned aerial vehicle in real time;
judging, based on the state parameter, whether the unmanned aerial vehicle is to be flown or to be retrieved in the handheld way; and
controlling a rotor wing to rotate to take off, in a case of determining that the unmanned aerial vehicle is to be flown in the handheld way; or
controlling the rotor wing to stop rotating, in a case of determining that the unmanned aerial vehicle is to be retrieved in the handheld way.

2. The method for flying and retrieving the unmanned aerial vehicle in the handheld way according to claim 1, wherein the determining that the unmanned aerial vehicle is to be retrieved in the handheld way comprises:
judging, based on the state parameter of the unmanned aerial vehicle, whether the unmanned aerial vehicle is interfered by a hand; and determining that the unmanned aerial vehicle is to be retrieved in the handheld way in a case that it is determined that the unmanned aerial vehicle is interfered by the hand.

3. The method for flying and retrieving the unmanned aerial vehicle in the handheld way according to claim 2, wherein the state parameter of the unmanned aerial vehicle comprises a position parameter and an attitude parameter of the unmanned aerial vehicle; and
the judging, based on the state parameter of the unmanned aerial vehicle, whether the unmanned aerial vehicle is interfered by the hand comprises:
obtaining an amount of position change of the unmanned aerial vehicle from the position parameter of the unmanned aerial vehicle;
obtaining an amount of attitude change of the unmanned aerial vehicle from the attitude parameter of the unmanned aerial vehicle; and
determining that the unmanned aerial vehicle is interfered by the hand in a case that the amount of position change of the unmanned aerial vehicle is greater than or equal to a preset position change amount threshold and the amount of attitude change of the unmanned aerial vehicle is greater than or equal to a preset attitude change amount threshold.

4. The method for flying and retrieving the unmanned aerial vehicle in the handheld way according to claim 1, wherein the determining that the unmanned aerial vehicle is to be flown in the handheld way comprises:
judging whether the unmanned aerial vehicle is triggered to be in a flight standby state;
determining whether the unmanned aerial vehicle is in a handheld flat-laying state for a predetermine time period, in a case that it is determined that the unmanned aerial vehicle is in the flight standby state; and
judging whether the unmanned aerial vehicle is released by comparing the state parameter of the unmanned aerial vehicle with a state parameter thereof at a previous time instant, in a case that it is determined that the unmanned aerial vehicle is in the handheld flat-laying sate; and determining that the unmanned aerial vehicle is to be flown in the handheld way if it is determined that the unmanned aerial vehicle is released.

5. The method for flying and retrieving the unmanned aerial vehicle in the handheld way according to claim 4, the judging whether the unmanned aerial vehicle is triggered to be in the flight standby state comprises judging whether a motion trajectory along which the unmanned aerial vehicle is raised by the hand follows a preset trajectory, which comprises:
detecting a position parameter (xᵢ, yᵢ, zᵢ) of the unmanned aerial vehicle at a time instant tᵢ, where xᵢ and yᵢ indicate two-dimensional coordinates on an x-axis and a y-axis in a horizontal plane parallel with the ground, zᵢ indicates a coordinate on a z-axis perpendicular to the ground, and tᵢ indicates a timestamp;
judging, based on xᵢ and yᵢ, whether components of the motion trajectory of the unmanned aerial vehicle along the x-axis and the y-axis extend monotonically along a positive direction or a negative direction of the x-axis and the y-axis respectively; judging, based on zᵢ, whether a component of the motion trajectory of the unmanned aerial vehicle along the z-axis extends monotonically along a positive direction of the z-axis; and
determining that the unmanned aerial vehicle is in the flight standby state, in case that it is determined that the components of the motion trajectory of the unmanned aerial vehicle along the x-axis and the y-axis extend monotonically along the positive direction or the negative direction of the x-axis and the y-axis respectively and the component of the motion trajectory of the unmanned aerial vehicle along the z-axis extends monotonically along the positive direction of the z-axis.

6. The method for flying and retrieving the unmanned aerial vehicle in the handheld way according to claim 4, wherein the determining that the unmanned aerial vehicle is in a handheld flat-laying state for the predetermined time period comprises:
obtaining an amount of position change of the unmanned aerial vehicle from the position parameter of the unmanned aerial vehicle;
obtaining an amount of attitude change of the unmanned aerial vehicle from the attitude parameter of the unmanned aerial vehicle; and
determining that the unmanned aerial vehicle is in the handheld flat-laying state in a case that the amount of position change of the unmanned aerial vehicle is less than a preset position change amount threshold and the amount of attitude change of the unmanned aerial vehicle is less than a preset attitude change amount threshold.

7. A device for flying and retrieving an unmanned aerial vehicle in a handheld way, comprising a state parameter detecting unit, a judging unit and a control unit, wherein
the state parameter detecting unit is configured to detect a state parameter of the unmanned aerial vehicle in real time;
the judging unit is configured to judge, based on the state parameter, whether the unmanned aerial vehicle is to be flown or to be retrieved in a handheld way; and
the control unit is configured to control a rotor wing to rotate to take off in a case that it is determined by the judging unit that the unmanned aerial vehicle is to be flown in the handheld way, or control the rotor wing to stop rotating in a case that it is determined by the judging unit that the unmanned aerial vehicle is to be retrieved in the handheld way.

8. The device for flying and retrieving the unmanned aerial vehicle in the handheld way according to claim 7, wherein the judging unit is configured to judge, based on the state parameter of the unmanned aerial vehicle, whether the unmanned aerial vehicle is interfered by a hand, and determine that the unmanned aerial vehicle is to be retrieved in the handheld way in a case that it is determined that the unmanned aerial vehicle is interfered by the hand; and
the judging unit comprises a position change amount obtaining subunit, an attitude change amount obtaining subunit and an interference judging subunit, wherein
the position change amount obtaining subunit is configured to obtain an amount of position change of the unmanned aerial vehicle from the position parameter of the unmanned aerial vehicle;
the attitude change amount obtaining subunit is configured to obtain an amount of attitude change of the unmanned aerial vehicle from the attitude parameter of the unmanned aerial vehicle; and
the interference judging subunit is configured to determine that the unmanned aerial vehicle is interfered by the hand, in a case that the amount of position change of the unmanned aerial vehicle is greater than or equal to a preset position change amount threshold and the amount of attitude change of the unmanned aerial vehicle is greater than or equal to a preset attitude change amount threshold.

9. The device for flying and retrieving the unmanned aerial vehicle in the handheld way according to claim 8, wherein the judging unit is configured to determine that the unmanned aerial vehicle is triggered to be in a flight standby state in a case that a motion trajectory along which the unmanned aerial vehicle is raised by the hand follows a preset trajectory; determine whether the unmanned aerial vehicle is in a handheld flat-laying state for a predetermined time period, in a case that it is determined that the unmanned aerial vehicle is in the flight standby state; judge whether the unmanned aerial vehicle is released by comparing the state parameter of the unmanned aerial vehicle with a state parameter thereof at a previous time instant in a case that it is determined that the unmanned aerial vehicle is in the handheld flat-laying state; and determine that the unmanned aerial vehicle is to be flown in the handheld way if it is determined that the unmanned aerial vehicle is released.

10. The device for flying and retrieving the unmanned aerial vehicle in the handheld way according to claim 9, wherein the judging unit further comprises a position parameter detecting subunit, a first judging subunit and a first determining subunit; wherein
the position parameter detecting subunit is configured to detect a position parameter (xᵢ, yᵢ, zᵢ) of the unmanned aerial vehicle at a time instant tᵢ, where xᵢ and yᵢ indicate two-dimensional coordinates on an x-axis and a y-axis in a horizontal plane parallel with the ground, zᵢ indicates a coordinate on a z-axis perpendicular to the ground, and tᵢ indicates a timestamp;
the first judging subunit is configured to judge, based on xᵢ and yᵢ, whether components of the motion trajectory of the unmanned aerial vehicle along the x-axis and the y-axis extend monotonically along a positive direction or a negative direction of the x-axis and the y-axis respectively; and judge, based on zᵢ, whether a component of the motion trajectory of the unmanned aerial vehicle along the z-axis extends monotonically along a positive direction of the z-axis; and
the first determining subunit is configured to determine that the unmanned aerial vehicle is in the flight standby state, in a case that the first judging subunit determines that the components of the motion trajectory of the unmanned aerial vehicle along the x-axis and the y-axis extend monotonically along the positive direction or the negative direction of the x-axis and the y-axis respectively and the component of the motion trajectory of the unmanned aerial vehicle along the z-axis extends monotonically along the positive direction of the z-axis.

11. The device for flying and retrieving the unmanned aerial vehicle in the handheld way according to claim 8, wherein the judging unit further comprises a handheld flat-laying state judging subunit; wherein
the handheld flat-laying state judging subunit is configured to determine that the unmanned aerial vehicle is in a handheld flat-laying state, in a case that the amount of position change of the unmanned aerial vehicle is less than a preset position change amount threshold and the amount of attitude change of the unmanned aerial vehicle is less than a preset attitude change amount threshold.
